(19) United States
(12) Patent Application Publication
(10) Pub. No.: US 2025/0123749 A1
(43) Pub. Date: Apr. 17, 2025

(54) DETECTION OF MEMORY ACCESSES

(71) Applicant: Intel Corporation, Santa Clara, CA (US)

(72) Inventors: Navneet SINGH, Bangalore (IN); Hugh WILKINSON, Newton, MA (US); Sushant KUMAR, Bengaluru (IN)

(21) Appl. No.: 19/000,448

(22) Filed: Dec. 23, 2024

Related U.S. Application Data
(63) Continuation-in-part of application No. 17/958,222, filed on Sep. 30, 2022.
(60) Provisional application No. 63/343,292, filed on May 18, 2022.

(51) Int. Cl. G06F 3/06

(52) U.S. Cl. CPC G06F 3/0611; G06F 3/0647; G06F 3/0673

(57) ABSTRACT

Examples described herein relate to hot page detection. Some examples include circuitry to provide a number of pages with access counts within a bucket of a histogram, wherein the bucket of the histogram is associated with a configured access count range; based on a distribution of access counts in the histogram being a first level, reduce the configured access count ranges of the different buckets of the histogram; determine a second level indicative of page access counts; and migrate data of pages from a far memory to a near memory based on the second level.

### RELATED APPLICATION

The present application is a continuation-in-part of U.S. patent application Ser. No. 17/958,222, filed Sep. 30, 2022 (Attorney Docket Number AE3857-US), which claims a priority to U.S. provisional patent application No. 63/343,292 filed May 18, 2022. The contents of those applications are incorporated herein in their entirety.

### DESCRIPTION

Data is stored in memory or storage. A time to retrieve and process data can be based on the type of memory or storage that stores the data and transmission latency of the data to a requester processor. Data can be characterized by frequency of accesses. Data can be considered cold if accessed less than a threshold number of times over a time interval. Data can be considered hot if accessed more than a second threshold number of times over the time interval. Numerous approaches perform hot and cold page tracking to determine page access activity of applications and virtual machines. Hotness or coldness of data can be considered in determining whether to storage data in a cache for access by a processor or migrate the data to a storage system, with higher access times.

### BRIEF DESCRIPTION OF THE DRAWINGS

FIG. 1 depicts an example system.

FIG. 2 depicts an example system.

FIG. 3 depicts an example system.

FIG. 4 depicts an example of a hot page detector (HPD).

FIG. 5 depicts an example histogram.

FIG. 6 depicts an example process.

FIG. 7 depicts an example computing system.

### DETAILED DESCRIPTION

An interface to a memory device can perform hot page detection and report hot page addresses in a memory device (e.g., Compute Express Link (CXL) attached memory device) to a host computer. Hot page detection (HPD) can utilize counters, report counts of pages for which the reference counts (e.g., reads or writes) fall within a configured range and report page addresses and reference counts for pages identified as hot. In the HPD, a page is identified to be a hot page if, during a past time interval, the number of references to the page has exceeded a subsequently configured threshold. The threshold is referred to as Hot Page Count Threshold (HPCT). The value of the HPCT is to identify only a portion of the referenced pages as candidates for migration to local memory, reducing the information reported to the processor and constraining the overhead of migrating the pages. The page addresses and reference counts of pages that are not hot will not be reported to the processor by the HPD. The HPD measures the time interval in configurable sub-epochs and epochs. The HPD supports configuration of the HPCT by generating a histogram with buckets of the histogram containing the number of pages with a reference count within the configurable range of the bucket. A processor can read the histogram bucket counters from memory mapped input output (MMIO) address space. A processor-executed driver can utilize such a histogram to determine a suitable threshold of page references for the configured time interval and select an HPCT value that will identify a suitable portion of the referenced pages as being hot.

For example, consider the histogram configured with bucket reference count ranges of 0-32, 33-64, 65-128, 129-256, 257-512, 513-1024, 1025-2048 and 2049-4095. For data collected by HPD, the corresponding histogram bucket count of pages could be respectively 1000, 1000, 100, 2000, 200, 1000, 500, and 200. These histogram results characterize the distribution of reference counts for 6000 pages. The bucket with the highest reference counts corresponds to 3.3% of the 6000 pages. An HPCT value of 2049 would identify 3.3% of the referenced pages as hot. The bucket with the second highest reference counts corresponds to 8.3% of the referenced pages. An HPCT value of 1025 would identify 11.7% of the referenced pages as hot, the sum of 3.3% and 8.3%. The bucket with the third highest reference counts corresponds to 16.7% of the referenced pages. An HPCT value of 513 would identify 28.3% of the referenced pages as hot, the sum of 3.3%, 8.3% and 16.7%. Using this histogram analysis, the HPD driver can select an HPCT value without analyzing the raw data that could readily exceed 64,000 page reference counts. The driver, by configuring the HPCT, can identify physical pages in attached memory that are being accessed more frequently so that a processor can migrate data in the physical pages to a local memory device that provides lower access times.

Consider again the histogram example above. If the target percentage of pages to identify as hot is 12.5%, the histogram offers explicit HPCT values for 11.7% and 28.3%, respectively 1025 and 513. There is some HPCT value less than 1025 that might result in identifying a number of pages that is hot closer to 12.5% but not exceeding that percentage. Various approaches can refine the analysis of the distribution without re-collecting the raw data. A first approach is that the HPD supports a hierarchy of histograms. For the example, the HPD can support one or more additional histograms characterizing the same page reference data with more buckets and smaller ranges. For the histogram bucket reflecting the number of pages with reference counts between 512 and 1024, there could be 4 ranges: 513-640, 641-768, 769-896 and 897-1024. The respective histogram sub-bucket counts could be 600, 250, 100 and 50. The driver would set an HPCT of 769. The processor can perform a finer grain analysis on the reference counts that are near the eventual HPCT value, reducing the overhead of the finer grain analysis. A second approach is for the driver to select the HPCT value that would exceed the target percentage of pages identified as hot. HPD can report the page addresses of the hot pages to the driver, and the driver can re-filter the pages with reference counts in the range 513-1024, identifying up to 50 pages with the highest reference counts as being hot, for a total of 750 hot pages, 12.5% of 6000. A mixture of the two approaches can be employed.

The ongoing use of the histogram derived HPCT for subsequent page reference counts that were not part of the original histogram is speculative and assumes that the distribution of reference counts will remain approximately the same. This will not always be the case. If the driver generates a new histogram and computes a new HPCT value, that HPCT value will correspond to the newly collected data. The operations described as being performed by the HPD driver to analyze the histogram(s) and set an HPCT value could be performed by the HPD, further offloading the processor.

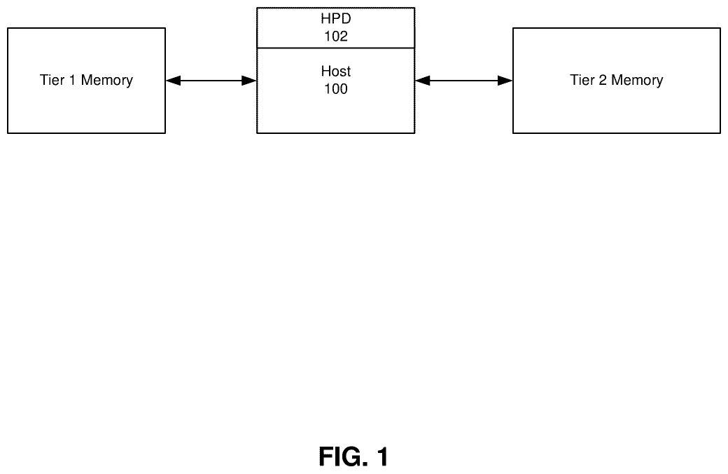

FIG. 1 depicts an example system. An example of Tier 1 memory includes Double Data Rate 5 (DDR5) attached memory. An example of Tier 2 memory can include CXL attached memory such as DDR5. Tier 1 memory can exhibit higher bandwidth and/or lower latency than that of Tier 2 memory. Data access times for commonly accessed data can be reduced by mapping data in frequently accessed virtual pages to physical pages in Tier 1 memory. For example, hot page detector (HPD) 100 can identify most frequently accessed virtual pages mapped to Tier 2 and host 102 can reallocate most frequently accessed pages from Tier 2 memory to Tier 1 memory.

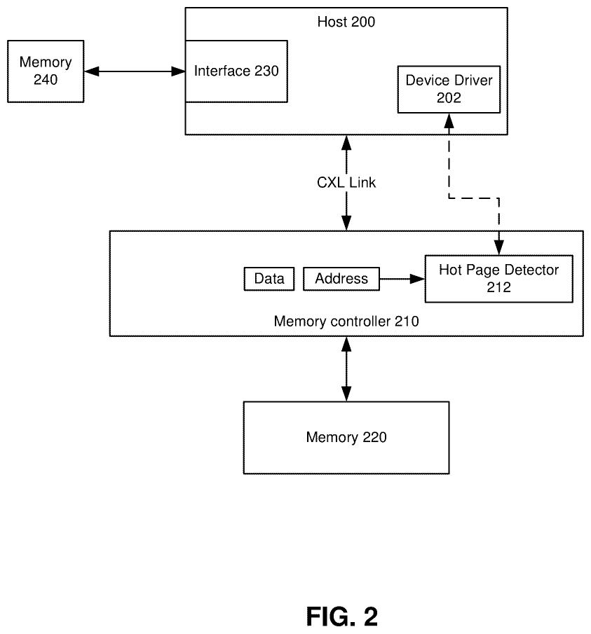

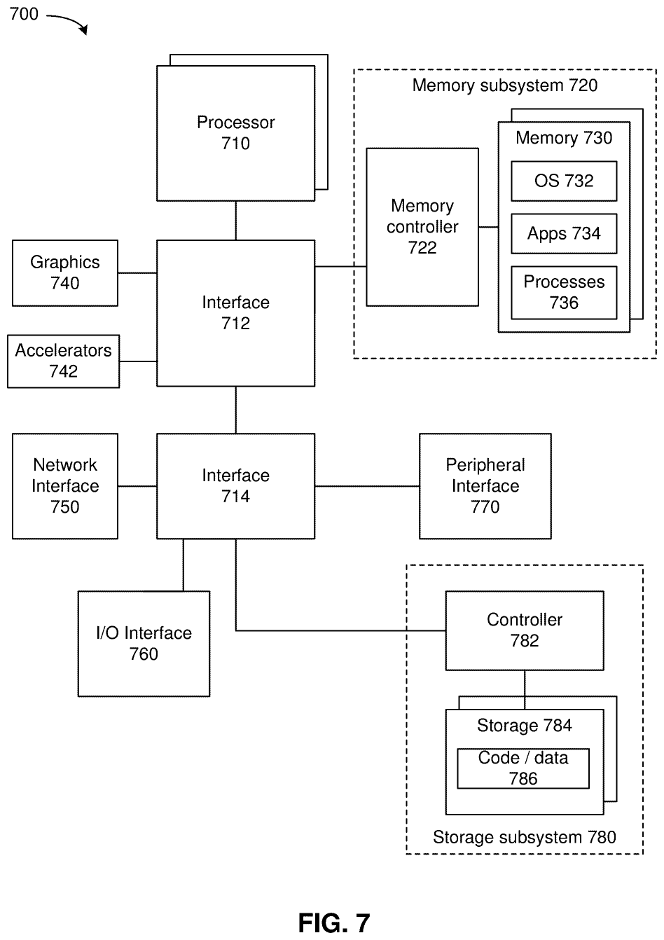

FIG. 2 depicts an example system. Host server system 200 can include processors that execute one or more processes, operating system (OS), and device driver 202. Various examples of hardware and software utilized by the host system are described at least with respect to FIG. 7. For example, processors can include one or more of: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry. Processes can include one or more of: application, process, thread, a virtual machine (VM), microVM, container, microservice, or other virtualized execution environment.

Driver 202 can provide processes or OS with communication to and from memory interface 210. As described herein, driver 202 can communicate with hot page detector 212 to determine a pages that are most frequently accessed (during time interval) in memory 220. Driver 202 can select ranges of counts of a histogram tracked by Hot Page Detector (HPD) 212. Histogram bucket ranges can be populated by counters of HPD 212, where a number of counters can be less than a number of pages tracked.

Host 200 can communicate with memory controller 210 using a device interface such as CXL.io over a CXL Link. Memory controller 210 can provide access to at least a CXL Type 3 Device and CXL.io and CXL.mem. See, for example, Compute Express Link (CXL) Specification version 1.1 (2020), as well as earlier versions, later versions, and variations thereof.

Memory controller 210 can provide a pooled memory controller for one or more attached hosts including host 200 for access to memory device 220. HPD 212 can be provided for one or more hosts. In some examples, HPD 210 can be accessible to host 200. HPD 210 can receive write or read request from a CXL link (or other link) and translate the write or read request to a DDR5 memory write or read request. HPD 210 can receive copies of addresses in requests. HPD 212 can utilize counters to count accesses to memory addresses or pages and record a histogram of access counts. Use of allocated counters can avoid counting a same physical page more than once because counters may not be de-allocated during histogram generation. A configurable hash index can be used for mapping pages to counters to load balance counters.

HPD device driver 202 can specify a threshold number of access counts or range of counts in the histogram that can be used to assess a distribution of access counts across sampled/measured pages. HPD device driver 202 can specify a time duration or epoch to perform a count of memory accesses and histogram generation. HPD 212 can deallocate counters after their corresponding pages are reported to the driver (hot pages) or a determination is made not to report the pages (cold pages) after the histogram is complete and the HPCT value is set by HPD device driver 202. In some examples, a time interval (epoch) for multiple counters can be the same, but the start of the time interval can depend on when the counter is allocated. A counter can be reported in the histogram after its time interval expires.

As described herein, HPD device driver 202 can adjust ranges of counts and/or time window size to control a number of pages that could be identified as hot and are to be migrated from memory 220 to memory 240 via network interface 230 or other device interface. HPD 210 can send, to HPD device driver 202, page addresses that correspond to one or more ranges of the histogram considered hot according to the value of the HPCT.

Memory device 220 can include one or more of: one or more registers, one or more cache devices (e.g., level 1 cache (L1), level 2 cache (L2), level 3 cache (L3), last level cache (LLC)), one or more volatile memory device, one or more non-volatile memory device, one or more persistent memory device, dual in-line memory modules (DIMMs), or one or more of memory pools. A memory pool can be accessed as a local device or a remote memory pool through a device interface (e.g., Peripheral Component Interconnect express (PCIe)), switch (e.g., CXL), and/or network. A memory pool can be shared by multiple servers or processors. Memory device 220 can include at least two levels of memory (alternatively referred to herein as “2LM” or tiered memory) can be used that includes cached subsets of system disk level storage (in addition to, for example, run-time data). This main memory includes a first level (alternatively referred to herein as “near memory”) including lower latency and/or higher bandwidth memory made of, for example, dynamic random access memory (DRAM) or other volatile memory; and a second level (alternatively referred to herein as “far memory”) which includes higher latency and/or lower bandwidth (with respect to the near memory) volatile memory (e.g., DRAM) or nonvolatile memory storage (e.g., flash memory or byte addressable non-volatile memory (e.g., Intel Optane®)). The far memory can be presented as “main memory” to the host operating system (OS), while the near memory can include a cache for the far memory that is transparent to the OS. The management of the two-level memory may be performed by a combination of circuitry and modules executed via the host central processing unit (CPU). Near memory may be coupled to the host system CPU via high bandwidth, low latency connection for low latency of data availability. Far memory may be coupled to the CPU via low bandwidth, high latency connection (as compared to that of the near memory), via a network or fabric, or a similar high bandwidth, low latency connection as that of near memory. Far memory devices can exhibit higher latency or lower memory bandwidth than that of near memory. For example, Tier 2 memory can include far memory devices and Tier 1 can include near memory. For example, memory 240 can be considered far memory.

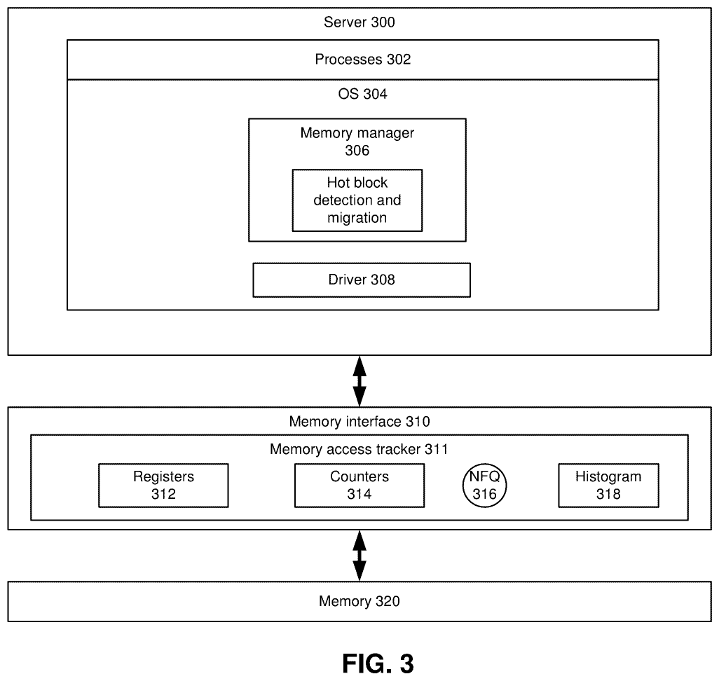

FIG. 3 depicts an example system. Server 300 can include one or more processors to execute one or more processes 302 and OS 304. In some examples, OS 304 can instead be implemented as a virtual machine manager (VM). OS 304 may access Notification Queue (NFQ) 316 and histogram data 318 to accumulate and process access data into memory manager-specific data structures to apply process-specific policies, adjust a level or threshold of accesses to data considered hot, adjust a time duration of monitoring data accesses, etc. Memory manager 306 can perform detection of or determination of a hot page threshold number in terms of number of accesses over an epoch based on histogram bin data 318 from memory interface 310. A histogram can store a distribution of pages with respect to the distribution of counts of accesses over a time duration (e.g., reads and/or writes). In some examples, different bins can include counts of accesses to different multiple spans of pages. HPD parameters can include one or more of: address ranges to be counted, block size and threshold to be used, epoch time (e.g., counters logically count their assigned address for epoch time duration), whether read accesses are counted, whether write accesses are counted, sub-sample counting (e.g., count 1 in every X accesses), and so forth.

For example, memory manager 306 can perform migration of data stored in detected hot blocks in far memory to near memory as well as migration of cold data from near memory to far memory. In some examples, hot data can be accessed more frequently than cold data. Driver 308 can configure memory interface 310 to selectively adjust a histogram bin size and/or time duration of page measurements to attempt to isolate a range of memory page access counts that are considered to store hot data, as described herein. A hot block threshold (HPCT) can be set for identifying hot block addresses based on number of accesses over a time duration. In some examples, a memory page can include 4,096 bytes, although other numbers of bytes can be associated with a memory page or larger or smaller granularity of memory address ranges can be tracked (e.g., cache line).

Memory interface 310 can receive and forward read and/or write requests to memory 320 and forward responses from memory 320 (e.g., data or status) to server 300. Memory access tracker (MAT) 311 can include technologies of HPD, in some examples. HPD can include technologies of MAT 311, in some examples. MAT 311 can be in a memory access path to receive and forward read and/or write requests to memory 320. MAT 311 can identify cache misses to memory (e.g., LLC or MSC). MAT 311 can be utilized per CXL port. In some examples, OS 304 can access memory tracker 311 as a CXL.mem device.

MAT 311 can count block-granular memory accesses, where a block size could be a same as or different than system page size. MAT 311 can perform access tracking using counters 314 that count read and/or write accesses at block granularity. Memory addresses can map to counters based on one counter per block, direct mapped, set-associative, etc. MAT 311 can perform host physical address (HPA) or device physical address (DPA) based counting and reporting to memory manager 306. MAT 311 may count recent accesses in a current defined epoch.

NFQ 316 can include a queue in system or device memory to share with page addresses and, optionally, counts of accesses of the hot page addresses. For example, driver 308 can configure operation of MAT 311 by writing to registers 312. Configuration of operation of MAT 311 can include specifying a size of one or more buckets in histogram (e.g., number of different pages associated with a bucket of range of access counts), access time duration over which counts of memory accesses (e.g., reads or writes) are recorded, threshold for identifying a bucket as hot, enable/disable counting of accesses, and others. Registers 312 can be implemented as memory mapped input output (MMIO) registers.

Memory interface 310 can provide server 300 with access to memory 320. Memory 320 can be implemented in a similar manner as that of memory 220.

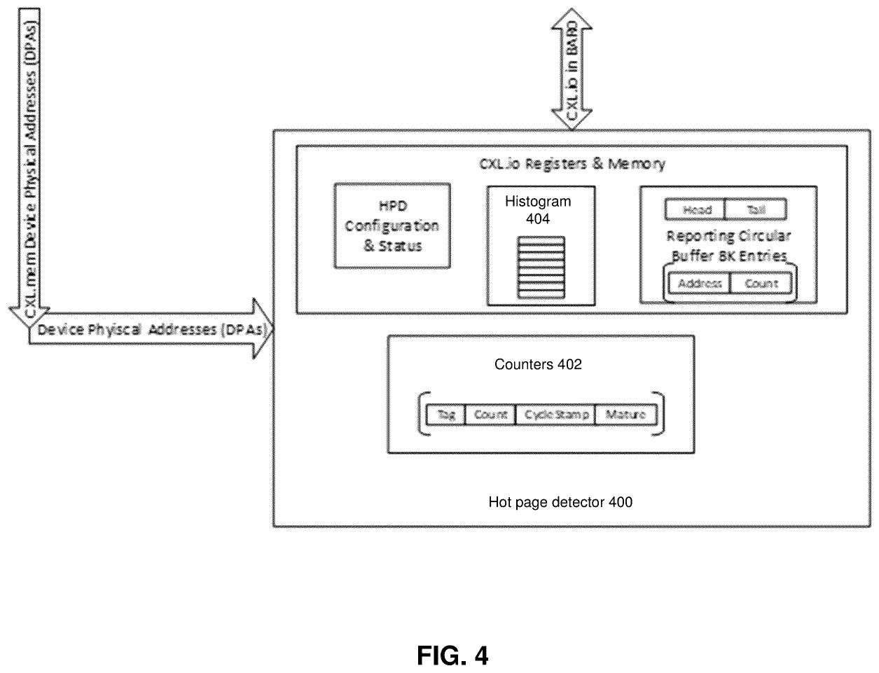

FIG. 4 depicts an example of a hot page detector (HPD). HPD 400 can be positioned in a CXL device or bridge or in host CXL controller (e.g., host CXL bridge). HPD 400 can translate CXL type 3 host physical addresses (e.g., memory buffer address) to memory device physical address. HPD 400 can utilize counters 402 to perform counting of accesses to pages mapped to bins of a histogram. For example, for 64 K pages, 64 K counters (or other number) can track accesses to pages. For example, entries in counters 402 can be accessed by a hash of device physical address (DPA).

In an entry in counters 402, the following Table 1 provides examples of data in a counter.

TABLE 1

| Field | Example data |
|---|---|
| Tag | Identify a page (e.g., bits 40-28 of device |
| | physical address (DPA)) |
| Count | Store a number of times page accessed during |
| | time of observations. Count can saturate if it |
| | reaches max value. |
| CycleStamp | Record when counter was allocated (time |
| | window). |
| Mature | Indicate whether a counting interval expired. |

Histogram data 404 can include two or more bins of groupings of different page access counts. A server-executed driver can set configuration and status of HPD 400 to specify at least bin sizes or bucket ranges (e.g., number of access counts associated with one or more bins) and time duration of measurement of accesses. Driver can provide HPD 400 with commands or register updates to start or stop building of histogram. In some examples, the driver does not access data of counters 402 but accesses histogram data 404 indicative of counts of memory accesses and corresponding numbers of pages. The driver can access circular buffer of reported addresses generated by HPD 400 to access detected hot page DPAs. In some examples, CXL.io or PCIe links can be utilized for communication between driver and HPD 400.

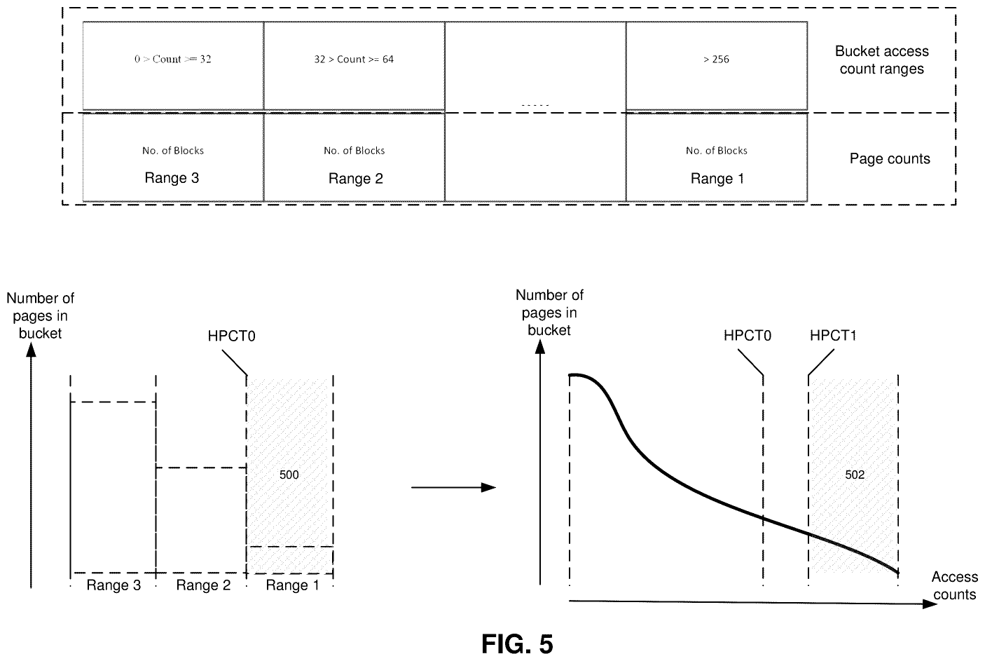

FIG. 5 depicts an example histogram. Histogram bucket ranges can correspond to ranges of counts. In some examples, a first bucket can record a number of blocks with number of accesses between 0 and 32, a second bucket can record a number of accesses between 33 to 64, and Nth bucket can record a number of accesses greater than 256.

As shown, value HPCT0 can cause migration of data stored in pages associated with region 500 can have access counts in range 1 that meet or exceed HPCT0. However, the pages that actually exceed HPCT0, shown as 500, may exceed the target percentage of pages to be identified as hot. A histogram can be an imprecise representation of page access count distribution where there are large ranges of values in a bucket and uneven distribution of access counts in a bucket. Various examples can reduce a granularity of access count range and identify pages that correspond to accesses that are accessed at or more than a threshold level. Accordingly, the HPCT value can be adjusted from HPCT0 to HPCT1 to cause migration of merely those identified pages in buckets corresponding to range 502. The analysis to determine HPCT1 can utilize a finer grain histogram to be calculated by either HPD or HPD driver.

Kernel software or HPD driver can adjust bucket range size based on histogram data. For example, a bucket range size can be increased to decrease the granularity of page hotness characterization. For example, bucket range size can be decreased to increase the granularity of page hotness characterization. For example, a target histogram configuration can result in X % of pages in upper buckets of counts. If a percentage of pages in upper bucket does not match the target percentage of hot pages, kernel software or HPD driver can adjust the histogram intervals to be smaller or larger or change histogram upper and lower limits. However, changing the histogram configuration applies to subsequent data collection and cannot re-characterize the data already collected or impact the migration of pages based upon that data.

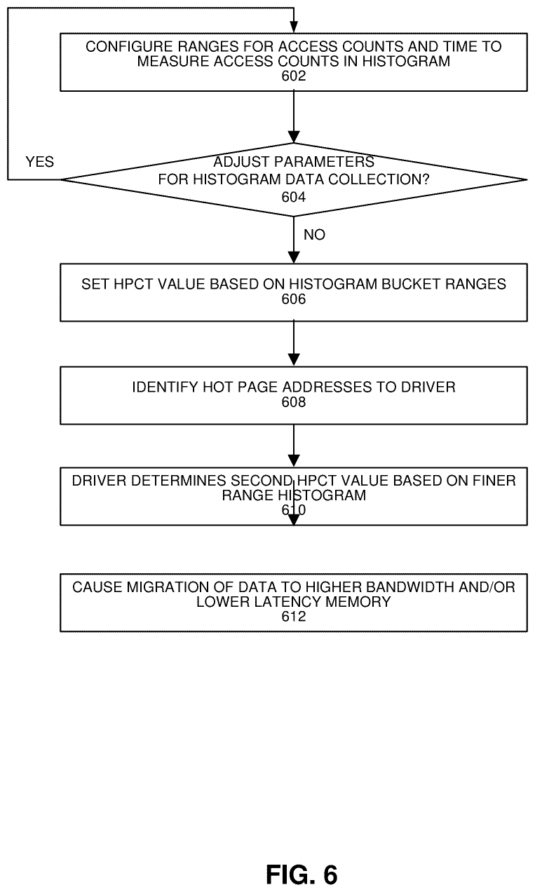

FIG. 6 depicts an example process to adjust a histogram. In some examples, the process can be performed by a server processor-executed driver, state machine in an HPD, or other software or circuitry. At 602, initiate histogram collection until the histogram has a sufficient population or until sufficient time has expired. Access counters are allocated to count the number of accesses to pages that are accessed for which allocation is enabled and available. HPCT can be set to an initial value of 0, the value that denotes that no HPCT value has been set and that histogram collection is enabled. Histogram collection can be disabled when the HPCT value is set to a non-zero value.

At 604, evaluate configuration to capture access counts for pages of the histogram based on a distribution of access counts in the histogram. For example, if the distribution of access counts does not indicate a threshold access count at and above which approximately 10% of the page counts reside in the histogram, the configuration can be updated. The percentage value can be set by a data center administrator or orchestrator. The configuration can include time duration to count accesses for page and reduce width of histogram limits per bucket or shift range of buckets. Based on adjustment of configuration, the process can return to 602. Based on non-adjustment of configuration, the process can proceed to 606.

At 606, an HPCT value can be set based on one or more buckets associated with highest access count(s) for which the aggregate population access count is greater than or equal to a configured percentage of the total aggregate population access count. Ranges can grow exponentially (e.g., 32, 64, 128, 256, 512, 1024, 2048 and 32767), or another manner (e.g., increase by multiples, logarithmic increase). In some examples, ranges can be uniform spans. The HPCT value can be set to the access count of the lower bound of one of the buckets. For example, referring to FIG. 5, HPCT1 can represent the access count of the lower bound of buckets in range 502. In the process of FIG. 6, the HPD driver can select an HPCT value that selects more pages than the target percentage (e.g., HPCT0 in FIG. 5) because, if the HPCT was set to the next higher lower bound, too few pages would be identified as hot.

At 608, HPD can report hot page addresses to an HPD driver by writing page addresses in the circular buffer to be read by the HPD driver. The HPD driver can access circular buffer of reported addresses generated by HPD to access detected hot page DPAs. In some examples, CXL.io or PCIe links can be utilized for communication between driver and HPD. The time to transfer the page information to the circular buffer depends upon the hardware arbitration for accessing the counters.

At 610, the HPD driver can filter out the excess pages reported as hot by HPD by determining a second, subsequent HPCT value by calculating a finer grained histogram for the reported pages and filtering out the candidate pages for migration with access counts below that threshold. For example, the finer grain histogram can be generated by the HPD driver after an elapse of a timer that indicates a number of HPD reported page addresses have been received to generate a finer grain histogram.

At 612, pages with an access count greater than or equal to the second HPCT can be submitted for page migration. Data associated with hot page addresses pages can be identified by the driver so that data in the hot page addresses can be migrated to higher bandwidth and/or lower latency memory.

At 614, the interval of time for a next measurement of access counts can be adjusted. Changing the interval of time can increasing page access counts because there is more time to count additional accesses. The increased counts can shift the distribution of counts in the subsequent histogram into buckets with higher access count ranges. Decreasing the time interval can shift the distribution to lower access counts. For instance, if all page access counts populate only a small fraction of the histogram buckets, the fidelity of the histogram may be low. Additionally, the HPCT may be higher than the number of accesses set for initialization of a page (e.g., 64 for a 4 KB page and cache line size of 64, the target HPCT is 65 or higher), as that would end up classifying every newly initialized page as hot.

FIG. 7 depicts an example computing system that can be used in a server or data center. Components of system 700 (e.g., processor 710, interface 712, memory controller 722, memory 730, I/O interface 760, controller 786, and so forth) to perform operations to determine hot and cold pages based on ranges of access counts and adjust range sizes, as described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a fixed function or programmable offload engine that can be accessed or used by a processor 710. For example, an accelerator among accelerators 742 can provide compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

In some examples, OS 732 can enable or disable circuitry to perform operations to determine hot and cold pages based on ranges of access counts and adjust range sizes, as described herein

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers, memory pools, or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can perform operations to update mappings of received packets to target processes or devices can be updated, as described herein.

Some examples of network interface 750 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. An example of a volatile memory include a cache. A non-volatile memory (NVM) device is a memory whose state is determinate even if power is interrupted to the device.

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chip-to-chip communications, die-to-die communications, packet-based communications, communications over a device interface, fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade can include components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), micro data center, on-premise data centers, off-premise data centers, edge network elements, fog network elements, and/or hybrid data centers (e.g., data center that use virtualization, serverless computing systems (e.g., Amazon Web Services (AWS) Lambda), content delivery networks (CDN), cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, Application programming interfaces (APIs), instruction sets, computing code, computer code, code segments, computer code segments, words, values, symbols, or combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or combination thereof, including “X, Y, and/or Z.”

Illustrative examples of the devices, systems, and methods disclosed herein are provided below. An embodiment of the devices, systems, and methods may include one or more, and combination of, the examples described below.
Example 1 includes one or more examples and includes an apparatus that includes: a memory interface comprising circuitry to: provide a number of pages with access counts within a bucket of a histogram, wherein the bucket of the histogram is associated with a configured access count range; based on a distribution of access counts in the histogram being a first level, reduce the configured access count ranges of the different buckets of the histogram; determine a second level indicative of page access counts; and migrate data of pages from a far memory to a near memory based on the second level.
Example 2 includes one or more examples, wherein the first level comprises a first percentage of pages being within a first number of the buckets.
Example 3 includes one or more examples, wherein the first level comprises a majority of pages being within a first number of the buckets.
Example 4 includes one or more examples, wherein the second level is to set a number of page access counts that trigger migration of the data of the pages to the far memory device.
Example 5 includes one or more examples, and comprising the near memory coupled to the memory interface, wherein the near memory is to store the pages.
Example 6 includes one or more examples, wherein the far memory comprises a memory pool.
Example 7 includes one or more examples, wherein the memory interface is to provide access to a memory device in a manner consistent at least with Compute Express Link (CXL).
Example 8 includes one or more examples, comprising a server coupled to the memory interface, wherein the server is to access the near memory by the memory interface.
Example 9 includes one or more examples, and includes at least one non-transitory computer-readable medium comprising instructions stored thereon, that if executed by one or more processors, cause the one or more processors to: execute a device driver to based on a distribution of access counts in a histogram being a first level, reduce configured access count ranges of buckets of the histogram; determine a second level indicative of page access counts; and migrate data of pages from a far memory to a near memory based on the second level.
Example 10 includes one or more examples, wherein the first level comprises a first percentage of pages being within a first number of the buckets.
Example 11 includes one or more examples, wherein the second level is to set a number of page access counts that trigger migration of the data of the pages to the device.
Example 12 includes one or more examples, wherein the far memory comprises a memory pool.
Example 13 includes one or more examples, wherein: a memory interface to the near memory is to provide the histogram by counting a number of accesses to the near memory over a duration of time.
Example 14 includes one or more examples, wherein: the far memory has a lower latency and/or lower bandwidth than the near memory.
Example 15 includes one or more examples, and includes a method comprising: accessing a number of pages with access counts within a bucket of a histogram, wherein the bucket of the histogram is associated with a configured access count range; based on a distribution of access counts in the histogram being a first level, reducing the configured access count ranges of the different buckets of the histogram; determining a second level indicative of page access counts; and based on the second level, causing migration of hot data from a near memory device to a far memory device.
Example 16 includes one or more examples, wherein the first level comprises a first percentage of pages being within a first number of the buckets.
Example 17 includes one or more examples, wherein the second level is to set a number of page access counts that trigger migration of the data of the pages to the far memory device.
Example 18 includes one or more examples, comprising a memory interface to the near memory providing the histogram by counting a number of accesses to the near memory over a duration of time.
Example 19 includes one or more examples, wherein the memory interface is to provide access to a memory device in a manner consistent at least with Compute Express Link (CXL).
Example 20 includes one or more examples, wherein: the far memory has a lower latency and/or lower bandwidth than a latency and/or bandwidth associated with the near memory.

1. An apparatus comprising:
a memory interface comprising
circuitry to:
provide a number of pages with access counts within a bucket of a histogram, wherein the bucket of the histogram is associated with a configured access count range;
based on a distribution of access counts in the histogram being a first level, reduce the configured access count ranges of the different buckets of the histogram;
determine a second level indicative of page access counts; and
migrate data of pages from a far memory to a near memory based on the second level.

2. The apparatus of claim 1, wherein the first level comprises a first percentage of pages being within a first number of the buckets.

3. The apparatus of claim 1, wherein the first level comprises a majority of pages being within a first number of the buckets.

4. The apparatus of claim 1, wherein the second level is to set a number of page access counts that trigger migration of the data of the pages to the far memory device.

5. The apparatus of claim 1, comprising the near memory coupled to the memory interface, wherein the near memory is to store the pages.

6. The apparatus of claim 1, wherein the far memory comprises a memory pool.

7. The apparatus of claim 1, wherein the memory interface is to provide access to a memory device in a manner consistent at least with Compute Express Link (CXL).

8. The apparatus of claim 1, comprising a server coupled to the memory interface, wherein the server is to access the near memory by the memory interface.

9. At least one non-transitory computer-readable medium comprising instructions stored thereon, that if executed by one or more processors, cause the one or more processors to:
execute a device driver to
based on a distribution of access counts in a histogram being a first level, reduce configured access count ranges of buckets of the histogram;
determine a second level indicative of page access counts; and
migrate data of pages from a far memory to a near memory based on the second level.

10. The computer-readable medium of claim 9, wherein the first level comprises a first percentage of pages being within a first number of the buckets.

11. The computer-readable medium of claim 9, wherein the second level is to set a number of page access counts that trigger migration of the data of the pages to the device.

12. The computer-readable medium of claim 9, wherein the far memory comprises a memory pool.

13. The computer-readable medium of claim 9, wherein:
a memory interface to the near memory is to provide the histogram by counting a number of accesses to the near memory over a duration of time.

14. The computer-readable medium of claim 9, wherein:
the far memory has a lower latency and/or lower bandwidth than the near memory.

15. A method comprising:
accessing a number of pages with access counts within a bucket of a histogram, wherein the bucket of the histogram is associated with a configured access count range;
based on a distribution of access counts in the histogram being a first level, reducing the configured access count ranges of the different buckets of the histogram;
determining a second level indicative of page access counts; and
based on the second level, causing migration of hot data from a near memory device to a far memory device.

16. The method of claim 15, wherein the first level comprises a first percentage of pages being within a first number of the buckets.

17. The method of claim 15, wherein the second level is to set a number of page access counts that trigger migration of the data of the pages to the far memory device.

18. The method of claim 15, comprising:
a memory interface to the near memory providing the histogram by counting a number of accesses to the near memory over a duration of time.

19. The method of claim 18, wherein the memory interface is to provide access to a memory device in a manner consistent at least with Compute Express Link (CXL).

20. The method of claim 15, wherein:
the far memory has a lower latency and/or lower bandwidth than a latency and/or bandwidth associated with the near memory.
